(19) United States
(12) Patent Application Publication
(10) Pub. No.: US 2022/0392011 A1
(43) Pub. Date: Dec. 8, 2022

(54) CUSTOMIZING CLEANING CYCLES

(71) Applicant: Micron Technology, Inc., Boise, ID (US)

(72) Inventors: Yunju Lee, Austin, TX (US); Shwetha Vure, Boise, ID (US); Barbara J. Bailey, Kuna, ID (US)

(21) Appl. No.: 17/337,989

(22) Filed: Jun. 3, 2021

(51) Int. Cl. G06T 1/00; G06K 9/00; G06K 9/62; A47L 15/42; A47L 15/46; A47L 15/37; A47L 15/44; G06N 20/00

(52) U.S. Cl. CPC G06T 1/0014; G06K 9/00624; G06K 9/6202; A47L 15/4295; A47L 15/46; A47L 15/37; A47L 15/4293; A47L 15/449; A47L 15/4287; A47L 15/4289; G06N 20/00; A47L 2401/04; A47L 2501/30; A47L 2501/06; A47L 2501/04; A47L 2501/07; A47L 2501/36

(57) ABSTRACT

A method includes receiving, at an artificial intelligence (AI) accelerator of a computing system, image data of one or more objects from an image sensor and performing an AI operation on the image data at the AI accelerator of the computing system using an AI model. The method further includes determining a custom cleaning cycle at the AI accelerator in response to performing the AI operation.

### TECHNICAL FIELD

Embodiments of the disclosure relate generally to customizing cleaning cycles, and more specifically, relate to customizing cleaning cycles for a cleaning device using artificial intelligence (AI).

### BACKGROUND

A computing system can be a computer, for example. The computing system can receive and/or transmit data and can include or be coupled to one or more memory devices. Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random-access memory (DRAM), static random-access memory (SRAM), synchronous dynamic random-access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random-access memory (RRAM), and magnetoresistive random access memory (MRAM), such as spin torque transfer random access memory (STT RAM), among others.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes an AI acceleration component in accordance with some embodiments of the present disclosure.

FIG. 2 illustrates an example cleaning device that includes a cleaning tool in accordance with some embodiments of the present disclosure.

FIG. 3 is a flow diagram corresponding to determining whether an object is clean in accordance with some embodiments of the present disclosure.

FIG. 4 illustrates an example cleaning device that includes a cleaning tool in accordance with some embodiments of the present disclosure.

FIG. 5 is a flow diagram of a method associated with determining a custom cleaning cycle using AI in accordance with some embodiments of the present disclosure.

FIG. 6 illustrates an example computing system that includes a memory sub-system in accordance with some embodiments of the present disclosure.

FIG. 7 is a block diagram of an example computer system in which embodiments of the present disclosure may operate.

### DETAILED DESCRIPTION

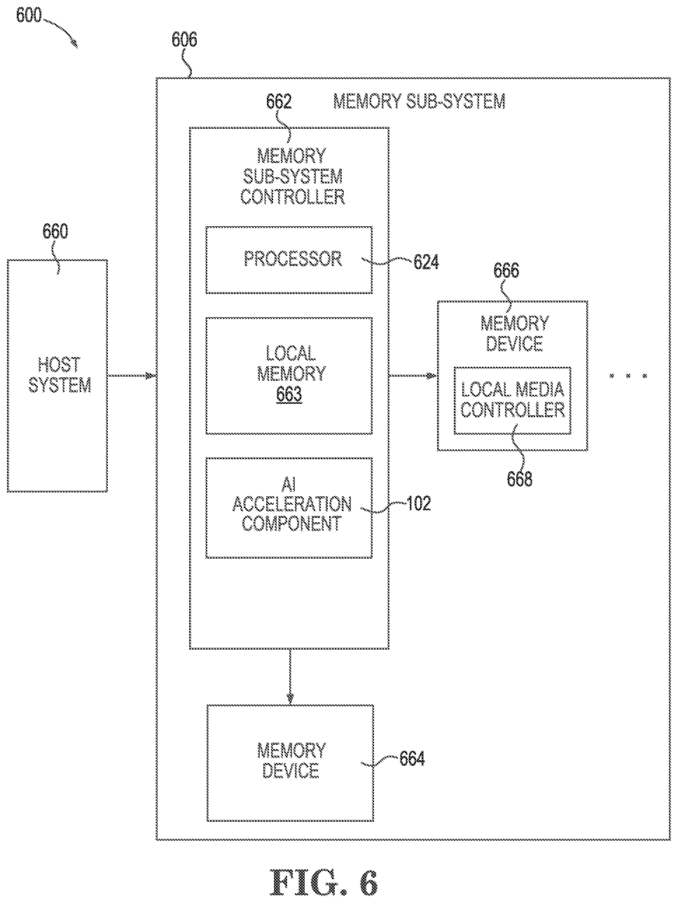

Aspects of the present disclosure are directed to customizing cleaning cycles using artificial intelligence (AI), in particular to memory sub-systems that include a memory sub-system AI acceleration component. A memory sub-system can be a storage system, storage device, a memory module, or a combination of such. An example of a memory sub-system is a storage system such as a solid-state drive (SSD). Examples of storage devices and memory modules are described below in conjunction with FIG. 6, et alibi. In general, a host system can utilize a memory sub-system that includes one or more components, such as memory devices that store data. The host system can provide data to be stored at the memory sub-system and can request data to be retrieved from the memory sub-system.

A cleaning device can clean one or more objects. A cleaning device can be, for example, a dishwasher, a washing machine, a vacuum, a carwash, a sterilizer, or any cleaning device used to clean an object. Current cleaning devices often are unsuccessful at efficiently and/or effectively cleaning an object. For example, an object can be effectively cleaned when a cleaning device removes debris (e.g., dirt, bodily fluids, food, and/or liquids, etc.) and/or sanitizes the object without damaging the object. An object can be efficiently cleaned when a cleaning device uses the least amount of resources, for example, water, water pressure, soap, and/or energy, to effectively clean the object.

A dishwasher and dishes are used herein as an example intended merely to facilitate an understanding of ways in which embodiments herein may be practiced. Accordingly, the dishwasher and dishes example should not be construed as limiting the scope of the embodiments herein. Dishwashers can receive one or more dishes in a load of dishes. Dishes can include, but are not limited to, plates, bowls, cups, glasses, silverware, cooking utensils, baking utensils, pans, pots, trays, and/or food storage containers, for example. Dishwashers can run a cleaning cycle, often selected by a user, to attempt to remove food and/or liquids and clean one or more dishes. The selected cleaning cycle may be an efficient and/or effective cleaning cycle to remove food and/or liquids from one dish and clean the dish but may not be the most efficient and/or effective cleaning cycle for the other dishes in the load. A dish can be effectively cleaned when a dishwasher removes food and/or liquid from the dish and/or sanitizes the dish without damaging the dish. A dish can be efficiently cleaned when a dishwasher uses the least amount of water, water pressure, soap, and/or energy to effectively clean the dish.

A cleaning device can be limited to a set of pre-determined cleaning cycles that may not be appropriate for a particular type of object and/or a particular type of debris attached to the object. For example, dishwashers can be limited to a set of pre-determined cleaning cycles that may not be appropriate for a particular type of dish or a particular type of food and/or liquid adhered to the dish. A shape, size, or material of a dish may dictate how a dish can be effectively and/or efficiently cleaned. Similarly, the type of food on a dish may determine how the food can be effectively and/or efficiently removed from the dish. Accordingly, a dish may not be fully cleaned if a selected pre-determined cycle was not selected based on the type of dish and/or the type of food on the dish. In some examples, a dish may even be damaged due to a pre-determined cycle using too hot of water or too high of water pressure on a particular type of dish, for example, fine china. Often dishwashers rely on too hot of water and/or too high of water pressure to remove residue from a dish since they do not include one or more cleaning tools. Cleaning tools can include, for example, abrasive materials, sponges, brushes, and/or towels to contact, scrub, and/or dry an object to clean the object.

Aspects of the present disclosure address the above and other deficiencies by determining a custom cleaning cycle based on image data of one or more objects and/or utilizing a cleaning tool to clean the one or more objects during a cleaning cycle. For example, an AI accelerator can determine a custom cleaning cycle based on image data of one or more objects from an image sensor.

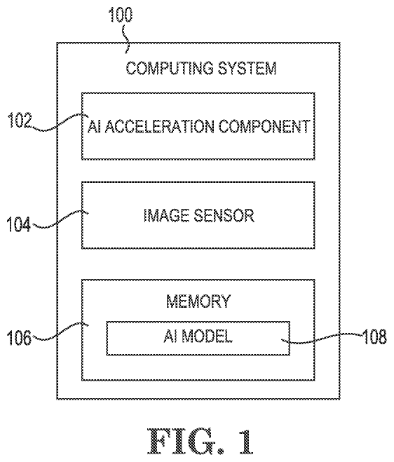

FIG. 1 illustrates an example computing system 100 that includes an AI acceleration component (e.g., AI accelerator) 102 in accordance with some embodiments of the present disclosure. The computing system 100 can further include an image sensor 104 and a memory sub-system (e.g., memory) 106.

The image sensor 104 can be a digital camera and/or a camera module that can convert an optical image into an electrical signal. The electrical signal can be included in image data. Image data of one or more objects can be generated using the image sensor 104. In some examples, the image sensor 104 can transmit the image data to the AI accelerator 102.

The AI accelerator 102 can include hardware, software, and/or firmware that is configured to enable the computing system 100 to perform operations (e.g., logic operations, among other operations) associated with AI operations using one or more AI models. In some embodiments, AI operations can include machine learning or neural network operations, which can include training operations or inference operations, or both.

Data stored in the memory 106 of the computing system 100 and/or external to the computing system 100 can be used in performing the AI operations. The memory 106 can store an AI model 108 and in some examples, the memory 106 can store the image data.

The AI model 108 can be trained on the computing system 100 and/or remotely. For example, the AI model 108 can be trained remotely in a cloud and transmitted to the computing system 100. Usage data, third-party data, manufacturer data, and/or object data, for example, can be used to train the AI model 108. Usage data can be image data, cleaning cycle data, previous image data and/or previous cleaning cycle data from the cleaning device. Third-party data can be previous image data and/or previous cleaning cycle data from other cleaning devices. Manufacturer data can be previous image data and/or previous cleaning cycle data from manufacturing testing done on the cleaning device, for example, during calibration of the cleaning device. Object data can be specifications and/or cleaning instructions for an object from a manufacturer and/or owner of the object. In some embodiments, a cloud and/or an AI accelerator 102 can include train parameters to train the AI model 108. Train parameters can include image data of one or more liquids, image data of one or more particulates, and/or image data of one or more objects, for example.

The computing system 100 can include and/or be coupled to a user interface. The user interface can be generated by the computing system 100. The user interface can be a graphical user interface (GUI) that can provide and receive information to and/or from the user of the computing system 100. In some approaches, the user interface can be shown on a display of the computing system 100. The user interface can receive commands from the computing system 100 to convey a message to a user. In some examples, the computing system 100 can further include a light and/or a speaker, which can also be used to convey messages to a user. For example, the computing system 100 can transmit a command to a user interface to display a message, a speaker to project a message, and/or a light to signal a message in response to determining an object is clean.

The computing system 100 can be coupled to one or more devices, for example a primary device. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like. The primary device can be a cleaning device, a personal laptop computer, a desktop computer, a smart phone, a tablet, a wrist-worn device, and/or redundant combinations thereof, among other types of computing devices.

The AI accelerator 102 of the computing system 100 can receive data from one or more devices including the primary device. Inputted data (e.g., received data) can be usage data, third-party data, manufacturer data, and/or object data. The AI accelerator 102 can perform an AI operation on all or a portion of the inputted data.

In some approaches, the AI accelerator 102 can determine a custom cleaning cycle in response to performing the AI operation. A custom cleaning cycle can be a cleaning cycle that specifies a water temperature, a water pressure, a water dispensing motion, a type of soap, an amount of soap, a cleaning tool, and/or a cleaning tool motion used to clean each object of the one or more objects in a cleaning device. For example, a dishwasher load can include a porcelain dinner plate with remnants of mashed potatoes and a wine glass with red wine stains. The AI accelerator 102 can determine a custom cleaning cycle for the porcelain dinner plate and the wine glass and continue to clean one or both dishes, adjusting the water temperature, the water pressure, the water dispensing motion, the type of soap, the amount of soap, the cleaning tool, and/or the cleaning tool motion until the image sensor 104 captures image data of the clean porcelain dinner plate and the clean wine glass.

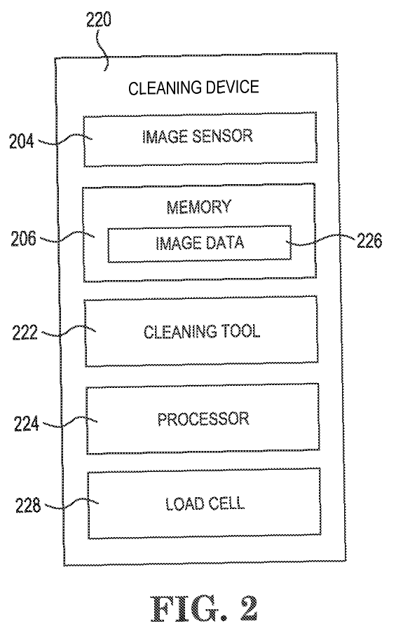

FIG. 2 illustrates an example cleaning device 220 that includes a cleaning tool 222 in accordance with some embodiments of the present disclosure. The cleaning device 220 can further include an image sensor 204, which can correspond to image sensor 104 in FIG. 1, and memory 206, which can correspond to memory 106 in FIG. 1. A processor 224 and/or a load cell 228 can also be included in cleaning device 220.

Cleaning device 220 can include cleaning tool 222 among one or more other cleaning tools. Cleaning tools can include, for example, abrasive materials, sponges, brushes, and/or towels and can be different shapes and sizes to clean and/or dry particular types of objects and/or remove particular types of debris.

Data can be stored in memory 206 of the cleaning device 220 and/or external to the cleaning device 220. The memory 206 can receive and store image data 226. The image data 226 can be received from the image sensor 204, other image sensors, other cleaning devices, a database and/or the Internet.

The memory 206 can be coupled to the processor 224 and can be a non-transitory computer readable medium having computer readable instructions (e.g., computer program instructions) stored thereon that are executable by the processor 224 to receive an image of an object from an image sensor, compare the image of the object to another image, determine the object is clean in response to the image of the object and the other image matching, and determine the object is dirty in response to the image of the object and the other image being different.

The cleaning device 220 can include one or more sensors including a load cell 228. The load cell 228 can be a transducer that converts force into a measurable electrical output. The load cell 228 can determine a weight of one or more objects. The processor 224 and/or the AI accelerator (e.g., AI accelerator 102 in FIG. 1) can receive sensor data including a weight of an object. The processor 224 and/or the AI accelerator can perform a processing operation and/or an AI operation on the sensor data to identify a type of object, whether the object is dirty, and/or a type of debris on the object. For example, the processor 224 and/or the AI accelerator can determine whether an object is plastic or glass at least partially based on the weight of the object. In some examples, the processor 224 and/or the AI accelerator can determine an object is dirty because it weights more than the object when it is clean.

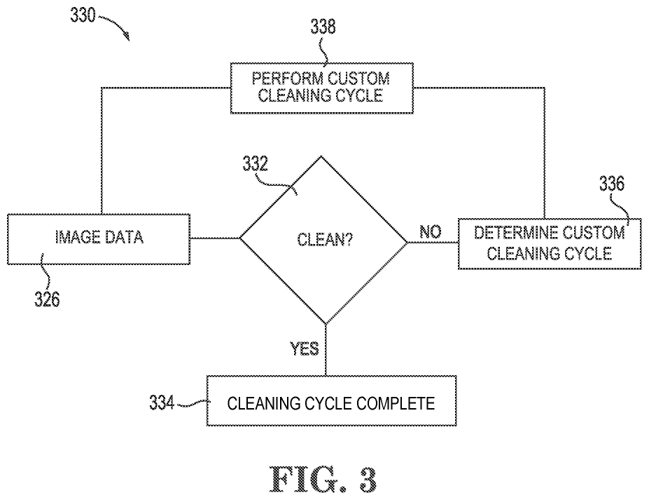

FIG. 3 is a flow diagram 330 corresponding to determining whether an object is clean in accordance with some embodiments of the present disclosure. Image data 326 can be received from an image sensor (e.g., image sensor 204 in FIG. 2), other image sensors, other cleaning devices, a database and/or the Internet. The image data 326 can include one or more images of objects.

The processor 224 of FIG. 2 can perform a processing operation and/or the AI accelerator 102 of FIG. 1 can perform an AI operation on the image data 326 to determine whether an object is clean. For example, at operation 332 the AI accelerator and/or the processor can determine using the image data 326 whether an object is clean. The AI accelerator and/or the processor can compare the image data 326 of the object to previous image data of one or more objects. For example, the AI accelerator and/or the processor can compare the image data 326 of the object to image data of a clean object. In some examples, the image data of the clean object can be received from a user device. For example, a user can capture an image of the object when it is clean and transmit the image data of the clean object to the AI accelerator and/or the processor. In response to a threshold number of pixels of the image data 326 matching image data of the clean object, the AI accelerator and/or processor can determine the object is clean. In response to the image data 326 having a number of matching pixels less than the threshold number, the AI accelerator and/or processor can determine the object is dirty. In some approaches, the AI accelerator and/or processor can compare the image data 326 to one or more dirty objects. In response to a threshold number of pixels of the image data 326 matching image data of a dirty object of the one or more dirty objects, the AI accelerator and/or processor can determine the object is dirty. In response to having a number of matching pixels of the image data 326 less than the threshold number, the AI accelerator and/or processor can determine the object is clean.

If the AI accelerator and/or the processor determines at operation 332 that the object is clean, then the cleaning cycle is complete 334. If the AI accelerator and/or the processor determines at operation 332 that the object is not clean, then the AI accelerator and/or the processor can determine a custom cleaning cycle 336 for the object. In some embodiments, the AI accelerator can perform an AI operation on previous cleaning cycle data and/or previous image data of the object to determine the custom cleaning cycle 336. For example, the AI accelerator can create a custom cleaning cycle 336 different from the previous cleaning cycle in response to determining that the previous cleaning cycle did not clean the object because the previous image data from prior to the previous cleaning cycle matches at least a portion of the image data 326 captured after the previous cleaning cycle.

Once the AI accelerator and/or the processor determines a custom cleaning cycle 336, the cleaning device can perform the custom cleaning cycle 338. In some embodiments, performing the custom cleaning cycle 338 can include a cleaning cycle that specifies a water temperature, a water pressure, a water dispenser motion, a type of soap, an amount of soap, a cleaning tool, and/or a cleaning tool motion used to clean the object. After performing the custom cleaning cycle 338, the process of flow diagram 330 can repeat until the object is determined to be clean.

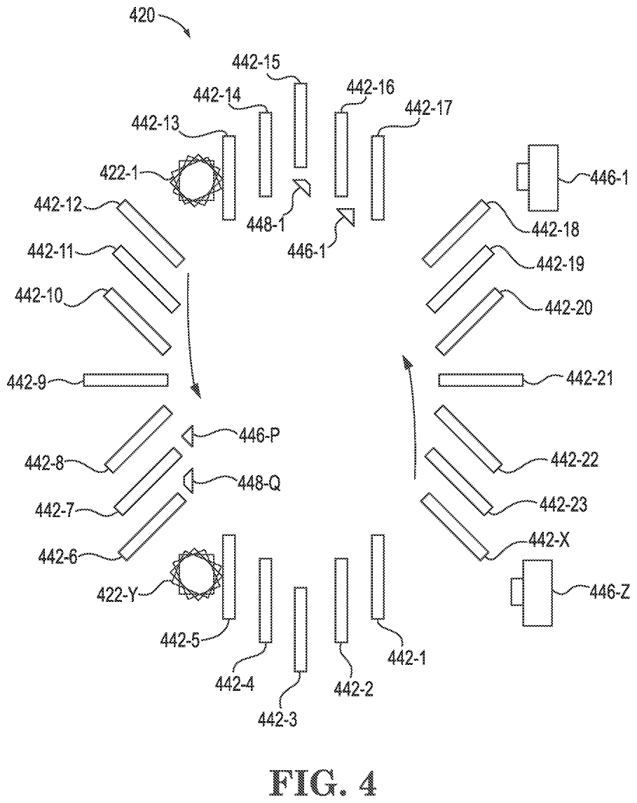

FIG. 4 illustrates an example dishwasher 420 that includes a cleaning tool 422 in accordance with some embodiments of the present disclosure. Dishwasher 420 can correspond to cleaning device 220 in FIG. 2 and cleaning tool 422 can correspond to cleaning tool 222 in FIG. 2. A cleaning device is illustrated as a dishwasher 420 and one or more objects are illustrated as one or more dishes in FIG. 4 merely to facilitate an understanding of ways in which embodiments herein may be practiced. The dishwasher 420 can include one or more cleaning tools 422-1, . . . , 422-Y, one or more image sensors 446-1, . . . , 446-Z, one or more water dispensers 446-1, . . . , 446-P, and one or more soap dispensers 448-1, . . . , 448-Q. One or more dishes 442-1, . . . , 442-X can be received by the dishwasher 420.

In some embodiments, the one or more dishes 442-1, . . . 442-X can be moved using, for example, a turntable or a conveyor mechanism. The one or more dishes 442-1, . . . , 442-X can be moved to interface with the one or more cleaning tools 444-1, . . . , 444-Y and to be visible to the one or more image sensors 446-1, . . . , 446-Z. In some approaches, the one or more cleaning tools 422-1, . . . , 422-Y, the one or more water dispensers 446-1, . . . , 446-P, the one or more soap dispensers 448-1, . . . , 448-Q, and/or the one or more image sensors 446-1, . . . , 446-Z may actuate instead of or in tandem with the one or more dishes 442-1, . . . , 442-X.

In some approaches, image sensor 446-1 can capture an image of one or more surfaces of each of the one or more dishes 442-1, . . . , 442-X. As illustrated in FIG. 4, image sensor 446-1 is capturing one or more surfaces of dish 442-17. An AI operation and/or a processing operation can be performed on the image data generated from the captured image of dish 442-17. The AI operation and/or the processing operation can determine the type of dish 442-17, the type of food on dish 442-17, and/or the type of liquid on dish 442-17.

The AI accelerator and/or processor can compare the image of dish 442-17 to a plurality of dish images. The plurality of dish images can be stored in memory coupled to the dishwasher 420 and/or received from the Internet, a computing system, and/or a cloud device. For example, a number of pixels of the image of dish 442-17 can be compared to a number of pixels of each of the plurality of dish images. A match can be determined in response to an image of the plurality of dish images having a threshold number of pixels matching a number of corresponding pixels of the image of dish 442-17.

Each dish image of the plurality of dish images can be associated with object data. The object data can be stored in memory coupled to the dishwasher 420 and/or received from the Internet, a computing system, and/or a cloud device. The object data can include specifications and/or cleaning instructions for a dish. The specifications can include material, weight, shape, and/or size of a dish and the cleaning instructions can include a water temperature, a water pressure, a water dispenser motion, a type of soap, an amount of soap, a cleaning tool, and/or a cleaning tool motion used to clean the dish.

The AI accelerator and/or processor can compare the image of dish 442-17 to one or more dirty dish images, food images, and/or liquid images. The one or more dirty dish images, food images, and/or liquid images can be stored in memory coupled to the dishwasher 420 and/or received from the Internet, a computing system, and/or a cloud device. For example, a number of pixels of the image of dish 442-17 can be compared to a number of pixels of each of the one or more dirty dish images, food images, and/or liquid images. A match can be determined in response to an image of the one or more dirty dish images, food images, and/or liquid images having a threshold number of pixels matching a number of pixels of the image of dish 442-17.

Each image of the one or more dirty dish images, food images, and/or liquid images can be associated with debris data (e.g., food and/or liquid data). The debris data can be stored in memory coupled to the dishwasher 420 and/or received from the Internet, a computing system, and/or a cloud device. The debris data can include cleaning instructions for that particular debris. The cleaning instructions can include a water temperature, a water pressure, a water dispenser motion, a type of soap, an amount of soap, a cleaning tool, and/or a cleaning tool motion used to clean the dish.

The AI accelerator and/or processor can use the dish specifications, the dish cleaning instructions, and/or the debris cleaning instructions to create a custom cleaning cycle. In some embodiments, dish cleaning instructions can be contrary to the debris cleaning instructions. For example, the dish cleaning instructions can include a maximum temperature of 100 degrees Fahrenheit and the debris cleaning instructions can include a minimum temperature of 115 degrees Fahrenheit. To prevent the dish from being damaged, the AI accelerator and/or processor can include a maximum temperature of 100 degrees Fahrenheit in the custom cleaning cycle. To remove the debris without increasing the temperature of the cleaning cycle, the AI accelerator and/or processor can determine to repeat the custom cleaning cycle a number of times and/or use a particular water dispenser motion, a particular soap, a particular quantity of soap, a particular cleaning tool, and/or a particular cleaning tool motion to clean the dish.

The dishwasher 420 can execute the custom cleaning cycle in response to receiving a command from the AI accelerator and/or processor. For example, the dishwasher 420 can spray water at a particular temperature, pressure, and/or in a particular motion from the one or more water dispensers 446-1, . . . , 446-P, spray a type of soap and/or a particular amount of soap from the one or more soap dispensers 448-1, . . . , 448-Q, use a particular cleaning tool of one or more cleaning tools 422-1, . . . , 422-Y, and/or have one or more of the cleaning tools 422-1, . . . , 422-Y use a particular motion to clean the dish in response to receiving the command from the AI accelerator and/or processor. A motion of one or more cleaning tools 422-1, . . . , 422-Y can include spinning at a particular speed, vibrating at a particular speed, contacting a dish with a particular force, and/or contacting a particular area of the dish. For example, the AI accelerator and/or processor can command cleaning tool 422-1 to contact a particular surface and/or a particular area of dish 442-13. The particular surface and/or area can be determined using an image of one or more surfaces of dish 442-13 captured by image sensor 446-Z. In some embodiments, the one or more surfaces of a dish captured by image sensor 446-Z can be different than the one or more surfaces of a dish captured by image sensor 446-1. For example, image sensor 446-1 can capture a first surface of a particular dish and image sensor 446-Z can capture a second surface of the particular dish.

The AI accelerator and/or processor can identify a group of pixels that are in a different color spectrum than the color spectrum of dish 442-13. The AI accelerator and/or processor can count the number of pixels from an edge and/or a number of edges of dish 442-13 to the group of pixels in the different color spectrum to determine the location and/or area of the food and/or liquid on dish 442-13. In some examples, the AI accelerator and/or processor can count the number of pixels from one or more datums in the dishwasher 420 to the group of pixels in the different color spectrum to determine the location and/or area of the food and/or liquid on dish 442-13. The AI accelerator and/or processor can transmit a command to cleaning tool 422-1 to clean the location and/or area of the food and/or liquid on dish 442-13. A command could also be transmitted from the AI accelerator and/or processor to one or more water dispensers 446-1, . . . , 446-P and/or one or more soap dispensers 448-1, . . . , 448-Q to spray water and/or soap on that location and/or area of dish 442-13

If the dishwasher 420 is unable to remove the food and/or liquid from the dish, the AI accelerator and/or processor can transmit a notification to a user interface of the dishwasher 420 and/or a computing system. In some examples, the dishwasher 420 can notify a user using a light and/or a speaker coupled to the dishwasher 420. For example, the dishwasher 420 can transmit a command to a user interface to display a message, a speaker to project a message, and/or a light to signal a message in response to determining a dish cannot be cleaned.

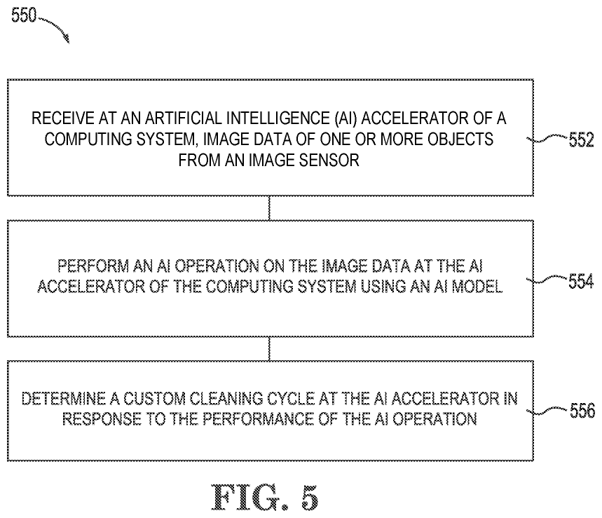

FIG. 5 is a flow diagram corresponding to a method 550 associated with customizing cleaning cycles using AI in accordance with some embodiments of the present disclosure. The method 550 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 550 is performed by the AI acceleration component 102 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 552, image data of one or more objects from an image sensor can be received at an AI accelerator of a computing system. In some embodiments, the computing system, the AI accelerator, the image sensor, and/or the image data can be analogous to computing system 100, AI acceleration component 102, and image sensor 104 illustrated in FIG. 1 and image data 226 illustrated in FIG. 2. In some embodiments, previous cleaning cycle data, previous image data of one or more objects, and/or a weight of one or more objects from a load cell can also be received at the AI accelerator.

At operation 554, an AI operation can be performed on the image data at the AI accelerator of the computing system using an AI model. In some embodiments, the AI model can be analogous to the AI model 108 illustrated in FIG. 1. The AI operation can also be performed on the previous cleaning cycle data, the previous image data of the one or more objects, and/or the weight of the one or more objects. In some approaches, the AI operation can identify a type of debris on the one or more objects or a type of object of the one or more objects based on the image data of the one or more objects, previous cycle data, previous image data of the one or more objects, and/or the weight of the one or more objects.

At operation 556, a custom cleaning cycle can be determined at the AI accelerator in response to the performance of the AI operation. The AI accelerator can determine the custom cleaning cycle based on the image data, the type of debris on the one or more objects, and/or the type of object of the one or more objects. The determined custom cleaning cycle can include a determined water temperature, water pressure, water dispenser motion, quantity of soap, type of soap, type of cleaning tool, and/or cleaning tool motion. In some approaches, the custom cleaning cycle can include a particular order of actions. For example, spray object with water, soap the object, use a scrubbing cleaning tool on the object, spray the object with water, and dry the object with a towel cleaning tool. The custom cleaning cycle can be performed on the one or more objects in response to the determination of the custom cleaning cycle at the AI accelerator. In some embodiments, additional image sensor data of the one or more objects can be received at the AI accelerator after the custom cleaning cycle has been performed on the one or more objects.

FIG. 6 illustrates an example computing system 600 that includes a memory sub-system 606 in accordance with some embodiments of the present disclosure. The memory sub-system 606 can include media, such as one or more volatile memory devices (e.g., memory device 664), one or more non-volatile memory devices (e.g., memory device 666), or a combination of such.

A memory sub-system 606 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 600 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 600 can include a host system 660 that is coupled to one or more memory sub-systems 606. In some embodiments, the host system 660 is coupled to different types of memory sub-system 662. FIG. 6 illustrates one example of a host system 660 coupled to one memory sub-system 606. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 660 can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system 660 uses the memory sub-system 606, for example, to write data to the memory sub-system 606 and read data from the memory sub-system 606.

The host system 660 can be coupled to the memory sub-system 606 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 660 and the memory sub-system 606. The host system 660 can further utilize an NVM Express (NVMe) interface to access components (e.g., memory devices 666) when the memory sub-system 606 is coupled with the host system 660 by the PCIe interface. The physical host interface can provide an interface for passing control, address, data, and other signals between the memory sub-system 606 and the host system 660. FIG. 6 illustrates a memory sub-system 606 as an example. In general, the host system 660 can access multiple memory sub-systems via a same communication connection, multiple separate communication connections, and/or a combination of communication connections.

The memory devices 664, 668 can include any combination of the different types of non-volatile memory devices and/or volatile memory devices. The volatile memory devices (e.g., memory device 664) can be, but are not limited to, random access memory (RAM), such as dynamic random-access memory (DRAM) and synchronous dynamic random access memory (SDRAM).

Some examples of non-volatile memory devices (e.g., memory device 666) include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 664, 666 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLC) can store multiple bits per cell. In some embodiments, each of the memory devices 666 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 666 can be grouped as pages that can refer to a logical unit of the memory device used to store data. With some types of memory (e.g., NAND), pages can be grouped to form blocks.

Although non-volatile memory components such as three-dimensional cross-point arrays of non-volatile memory cells and NAND type memory (e.g., 2D NAND, 3D NAND) are described, the memory device 666 can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

The memory sub-system controller 662 (or controller 662 for simplicity) can communicate with the memory devices 666 to perform operations such as reading data, writing data, or erasing data at the memory devices 666 and other such operations. The memory sub-system controller 662 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 662 can be a microcontroller, special purpose logic circuitry (e.g., a field programmable gate array (FPGA), an application specific integrated circuit (ASIC), etc.), or other suitable processor.

The memory sub-system controller 662 can include a processor 624 (e.g., a processing device) configured to execute instructions stored in a local memory 663. In the illustrated example, the local memory 663 of the memory sub-system controller 662 includes an embedded memory configured to store instructions for performing various processes, operations, logic flows, and routines that control operation of the memory sub-system 606, including handling communications between the memory sub-system 606 and the host system 660.

In some embodiments, the local memory 663 can include memory registers storing memory pointers, fetched data, etc. The local memory 663 can also include read-only memory (ROM) for storing micro-code. While the example memory sub-system 606 in FIG. 6 has been illustrated as including the memory sub-system controller 662, in another embodiment of the present disclosure, a memory sub-system 606 does not include a memory sub-system controller 662, and can instead rely upon external control (e.g., provided by an external host, or by a processor or controller separate from the memory sub-system).

In general, the memory sub-system controller 662 can receive commands or operations from the host system 660 and can convert the commands or operations into instructions or appropriate commands to achieve the desired access to the memory device 666 and/or the memory device 664. The memory sub-system controller 662 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 666. The memory sub-system controller 662 can further include host interface circuitry to communicate with the host system 660 via the physical host interface. The host interface circuitry can convert the commands received from the host system into command instructions to access the memory device 666 and/or the memory device 664 as well as convert responses associated with the memory device 666 and/or the memory device 664 into information for the host system 660.

The memory sub-system 606 can also include additional circuitry or components that are not illustrated. In some embodiments, the memory sub-system 606 can include a cache or buffer (e.g., DRAM) and address circuitry (e.g., a row decoder and a column decoder) that can receive an address from the memory sub-system controller 662 and decode the address to access the memory device 666 and/or the memory device 664.

In some embodiments, the memory device 666 includes local media controllers 668 that operate in conjunction with memory sub-system controller 662 to execute operations on one or more memory cells of the memory devices 666. An external controller (e.g., memory sub-system controller 662) can externally manage the memory device 666 (e.g., perform media management operations on the memory device 666). In some embodiments, a memory device 666 is a managed memory device, which is a raw memory device combined with a local controller (e.g., local controller 668) for media management within the same memory device package. An example of a managed memory device is a managed NAND (MNAND) device.

The memory sub-system 606 can include an AI acceleration component 102. The AI acceleration component 102 can be referred to in the alternative as an “AI accelerator.” Although not shown in FIG. 6 so as to not obfuscate the drawings, the AI acceleration component 102 can include various circuitry to facilitate performance of AI operations to manage consumables, as described herein. In some embodiments, the AI acceleration component 102 can include special purpose circuitry in the form of an ASIC, FPGA, state machine, and/or other logic circuitry that can allow the AI acceleration component 102 to orchestrate and/or perform operations described herein involving the memory device 666 and/or the memory device 664.

In some embodiments, the memory sub-system controller 662 includes at least a portion of the AI acceleration component 102. For example, the memory sub-system controller 662 can include a processor 624 (processing device) configured to execute instructions stored in local memory 663 for performing the operations described herein. In some embodiments, the AI acceleration component 102 is part of the host system 660, an application, or an operating system.

In a non-limiting example, an apparatus (e.g., the computing system 600) can include an AI acceleration component 102. The AI acceleration component 102 can be resident on the memory sub-system 606. As used herein, the term “resident on” refers to something that is physically located on a particular component. For example, the AI acceleration component 102 being “resident on” the memory sub-system 606 refers to a condition in which the hardware circuitry that comprises the AI acceleration component 102 is physically located on the memory sub-system 606. The term “resident on” can be used interchangeably with other terms such as “deployed on” or “located on,” herein.

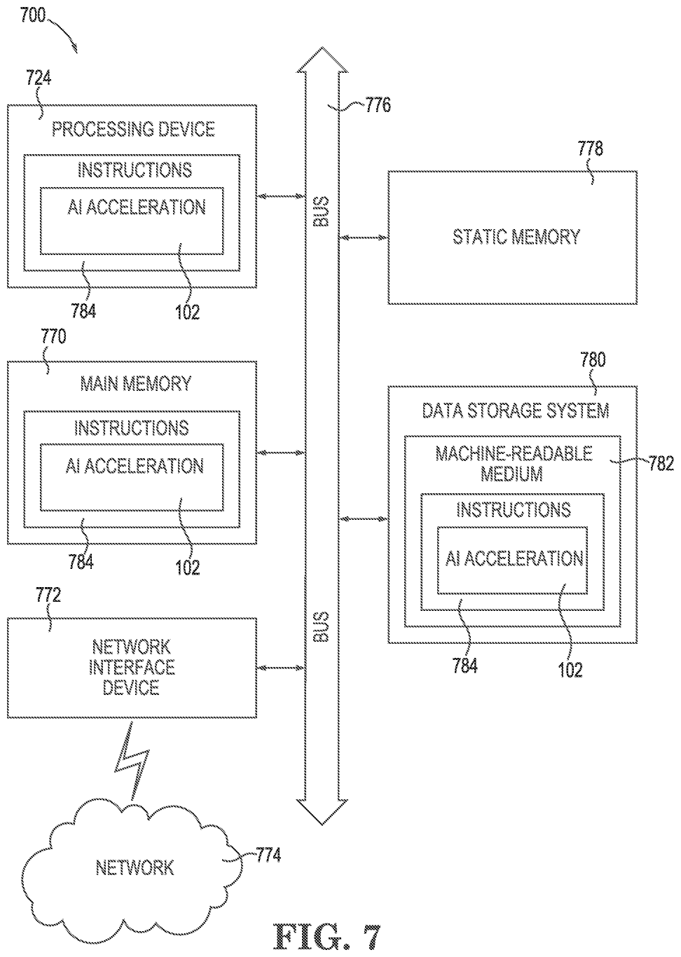

FIG. 7 is a block diagram of an example computer system 700 in which embodiments of the present disclosure may operate. For example, FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 660 of FIG. 6) that includes, is coupled to, or utilizes a memory sub-system (e.g., the memory sub-system 606 of FIG. 6) or can be used to perform the operations of a controller (e.g., to execute an operating system to perform operations corresponding to the AI acceleration component 102 of FIG. 1 and FIG. 6). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 724, a main memory 770 (e.g., read-only memory (ROM), flash memory, dynamic random access memory (DRAM) such as synchronous DRAM (SDRAM) or Rambus DRAM (RDRAM), etc.), a static memory 778 (e.g., flash memory, static random access memory (SRAM), etc.), and a data storage system 780, which communicate with each other via a bus 776.

The processing device 724 can correspond to processor 224 of FIG. 2 and can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 724 can also be one or more special-purpose processing devices such as an application specific integrated circuit (ASIC), a field programmable gate array (FPGA), a digital signal processor (DSP), network processor, or the like. The processing device 724 is configured to execute instructions 784 for performing the operations and steps discussed herein. The computer system 700 can further include a network interface device 772 to communicate over the network 774.

The data storage system 780 can include a machine-readable storage medium 782 (also known as a computer-readable medium) on which is stored one or more sets of instructions 784 or software embodying any one or more of the methodologies or functions described herein. The instructions 784 can also reside, completely or at least partially, within the main memory 770 and/or within the processing device 724 during execution thereof by the computer system 700, the main memory 770 and the processing device 724 also constituting machine-readable storage media. The machine-readable storage medium 782, data storage system 780, and/or main memory 770 can correspond to the memory sub-system 606 of FIG. 6.

In one embodiment, the instructions 784 include instructions to implement functionality corresponding to an AI acceleration component 102 (e.g., the AI acceleration component 102 of FIG. 1 and FIG. 6). While the machine-readable storage medium 782 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving, at an artificial intelligence (AI) accelerator of a computing system, image data of one or more objects from an image sensor;
performing an AI operation on the image data at the AI accelerator of the computing system using an AI model; and
determining a custom cleaning cycle at the AI accelerator in response to performing the AI operation.

2. The method of claim 1, further comprising:
receiving, at the AI accelerator of the computing system, at least one of: previous cleaning cycle data or previous image data of the one or more objects; and
performing the AI operation on the image data and at least one of: the previous cleaning cycle data or the previous image data of the one or more objects.

3. The method of claim 1, further comprising performing the custom cleaning cycle on the one or more objects in response to determining the custom cleaning cycle at the AI accelerator.

4. The method of claim 1, wherein determining the custom cleaning cycle includes determining at least one of: a water temperature, a water pressure, a quantity of soap, a type of soap, a type of cleaning tool, or a cleaning tool motion.

5. The method of claim 1, wherein performing the AI operation includes at least one of: identifying a type of debris on the one or more objects or a type of object of the one or more objects based on at least one of: the image data of the one or more objects, previous cycle data, or previous image data of the one or more objects.

6. The method of claim 5, further comprising determining the custom cleaning cycle based on at least one of: the type of the debris on the one or more objects or the type of object of the one or more objects.

7. The method of claim 1, further comprising:
receiving, at the AI accelerator of the computing system, a weight of the one or more objects from a load cell; and
performing the AI operation on the image data and the weight of the one or more objects at the AI accelerator of the computing system using the AI model.

8. The method of claim 7, wherein performing the AI operation includes identifying a type of object of the one or more objects based on at least one of: the image data of the one or more objects or the weight of the one or more objects.

9. The method of claim 1, further comprising:
performing the custom cleaning cycle on the one or more objects; and
receiving, at the AI accelerator, additional image sensor data of the one or more objects after performing the custom cleaning cycle on the one or more objects.

10. An apparatus, comprising:
a cleaning tool configured to clean an object during a cleaning cycle;
an image sensor configured to generate an image of the object after the cleaning cycle is complete; and
a processor configured to:
receive the image of the object from the image sensor;
compare the image of the object to another image;
determine the object is clean in response to the image of the object and the other image matching; and
determine the object is dirty in response to the image of the object and the other image being different.

11. The apparatus of claim 10, wherein the other image includes a clean object.

12. The apparatus of claim 10, wherein the processor is configured to receive the other image from a processor of a user device.

13. The apparatus of claim 10, further comprising an additional cleaning tool, wherein the cleaning tool is configured to clean a first surface of the object and the additional cleaning tool is configured to clean a second surface of the object.

14. The apparatus of claim 13, further comprising an additional image sensor, wherein the image sensor is configured to generate an image of the first surface of the object and the additional image sensor is configured to generate an image of the second surface of the object.

15. The apparatus of claim 10, wherein the processor is configured to transmit a command to a cleaning device to perform another cleaning cycle in response to determining the object is dirty.

16. The apparatus of claim 10, wherein the processor is configured to transmit a command to at least one of: a computing device, a user interface, a light, or a speaker in response to determining the object is clean.

17. A system, comprising:
a cleaning tool of a cleaning device, wherein the cleaning tool is configured to clean an object during a cleaning cycle;
an image sensor of the cleaning device, wherein the image sensor is configured to generate an image of the object; and
an artificial intelligence (AI) accelerator configured to:
receive the image from the image sensor;
perform an AI operation on the image at the AI accelerator using an AI model;
determine one or more commands for cleaning the object at the AI accelerator in response to performing the AI operation; and
transmit the one or more commands to at least one of: the cleaning tool or the cleaning device.

18. The system of claim 17, wherein the one or more commands include at least one of: the cleaning device dispensing water at a particular temperature, the cleaning device dispensing water at a particular pressure, or the cleaning device dispensing water in a particular motion.

19. The system of claim 17, wherein the one or more commands include at least one of: the cleaning device dispensing a particular type of soap or the cleaning device dispensing a particular quantity of soap.

20. The system of claim 17, wherein the one or more commands include moving the cleaning tool in a particular motion.
